(19) United States
(12) Patent Application Publication
(10) Pub. No.: US 2008/0005151 A1
(43) Pub. Date: Jan. 3, 2008

(54) Method and apparatus for creating index, and computer program product

(75) Inventor: Tomoya Iwakura, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/589,403

(22) Filed: Oct. 30, 2006

(30) Foreign Application Priority Data
Jun. 30, 2006 (JP) 2006-182251

(51) Int. Cl. G06F 7/00

(52) U.S. Cl. 707/102

(57) ABSTRACT

An index-item extracting unit extracts an index item that forms an index of an electronic document, together with appearing position information of the index item, from the electronic document. An index-list creating unit creates link information that includes the appearing position in the electronic document of the extracted index item as a link, attaches the created link information to the index item, and creates an index list by arranging the index item to which the link information is attached.

### BACKGROUND OF THE INVENTION

1. Field of the Invention

The present invention relates to a technology for creating an index from an electronic document.

2. Description of the Related Art

Conventional techniques have been proposed for effectively browsing a document group including a plurality of documents. For example, Japanese Patent No. 3445800 discloses a technique that enables the user of a computerized document group to directly search for information included in the documents. A full-text index of appearing positions of all characters in all documents, in the document group, and a feature index of the appearing positions of characters relating to place names, numerical quantities, and dates in all the documents, are created. A search term (character string to be searched in the full-text index), a search feature category (place name, numerical quantity, or date), and a range (for example, the range for a search feature category of ‘place name’ can be ‘Tokyo’ or the like) are received from the user, and texts that include character strings expressing features relating to the search term within the range are displayed as the search results. For example, if the search term is ‘uprising’, the search feature is ‘place name’, and the range is ‘Japan’, a text relating to an uprising in Japan in a place named ‘Makabe County’ is displayed: ‘In view of the uprising in Makabe County, the government . . . .’

Japanese Patent Application Laid-open No. 2002-342373 discloses a technique that helps the user to find a desired document from a large quantity of search results. According to this technique, the full-text search index of the appearing positions of all characters in all documents in the document group being searched, and a noun phrase index that stores noun phrases extracted from the document group being searched, are created. When a search term is received from the user, a search result indicating the existence of documents including the search term in the full-text index is displayed, and noun phrases for further narrowing the search result are extracted from the noun phrase index and displayed. For example, if a search term of ‘recycle’ is received, documents including ‘recycle’ are retrieved from the full-text index and their existence is displayed as the search result. In addition, noun phrases including ‘recycle’, such as a ‘recycle aluminum cans’ and ‘recycle network’ are extracted from the noun phrase index, and are displayed as search terms for further narrowing the documents of the search result.

These techniques narrow the focus on the contents of the document group to obtain information included in the documents, and cannot broadly ascertain what is written in the documents. A list of contents and an index make it possible to broadly ascertain what is written in a document. An index is ‘an alphabetical list of items such as names and words included in a written text, together with numbers of the pages on which those items appear.’ As conventional techniques for automatically creating an index, character strings forming the index are received beforehand and the index is formed automatically at the time of creating the document, or a database such as a biographical dictionary and a vocabulary dictionary is stored and an index of these items is created automatically when items of the dictionary are included in the document.

These conventional techniques for automatically creating an index are problematic in that they only create an index (merely by displaying index items and the pages where they appear), and do not provide a moving interface to the locations of the index items in an electronic document, making it impossible for the user to speedily refer to the locations of the index items.

### SUMMARY OF THE INVENTION

It is an object of the present invention to at least partially solve the problems in the conventional technology.

A computer program product according to one aspect of the present invention includes a computer usable medium having computer readable program codes embodied in the medium that when executed causes a computer to execute extracting an index item that forms an index of an electronic document, together with appearing position information of the index item, from the electronic document; and index-list creating including creating link information that includes an appearing position in the electronic document of the extracted index item as a link, from the appearing position information, attaching the created link information to the index item, and creating an index list by arranging the index items to which the link information is attached.

An apparatus for creating an index from an electronic document, according to another aspect of the present invention, includes an index-item extracting unit that extracts an index item that forms the index of the electronic document, together with appearing position information of the index item, from the electronic document; and an index-list creating unit that creates link information that includes the appearing position in the electronic document of the extracted index item as a link, attaches the created link information to the index item, and creates an index list by arranging the index item to which the link information is attached.

A method of creating an index from an electronic document, according to still another aspect of the present invention, includes extracting an index item that forms the index of the electronic document, together with appearing position information of the index item, from the electronic document; and index-list creating including creating link information that includes the appearing position in the electronic document of the extracted index item as a link, attaching the created link information to the index item, and creating an index list by arranging the index item to which the link information is attached.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram of a summary and features of an index creating apparatus according to a first embodiment of the present invention;

FIG. 2 is an explanatory diagram of the summary and features of the index creating apparatus according to the first embodiment;

FIG. 3 is a block diagram of a configuration of the index creating apparatus according to the first embodiment;

FIG. 4 is an example of information stored in an index-information storing unit;

FIG. 5 is an explanatory diagram of an index-information extracting unit;

FIG. 6 is an explanatory diagram of an index-information sorting unit;

FIG. 7 is an explanatory diagram of creation of a linked index list;

FIG. 8 is a flowchart of a process performed by an index-creation control unit;

FIG. 9 is an example of a screen of an output unit according to the first embodiment;

FIG. 10 is a block diagram of a configuration of an index creating apparatus according to a second embodiment of the present invention;

FIG. 11 is an example of information stored by a score storing unit;

FIG. 12 is an explanatory diagram of an index-information extracting unit;

FIG. 13 is an example of a screen of an output unit according to the second embodiment;

FIG. 14 is a block diagram of a configuration of an index creating apparatus according to a third embodiment of the present invention;

FIG. 15 is an example of a screen of an output unit according to the third embodiment;

FIG. 16 is an explanatory diagram of changes in attributes of specific expressions due to weighting;

FIG. 17 is an example of a method of sorting index items;

FIG. 18 is an example of a screen of an output unit according to a fourth embodiment of the present invention;

FIG. 19 is another example of a screen of the output unit according to the fourth embodiment; and

FIG. 20 is a block diagram of a computer that executes an index creating program.

### DETAILED DESCRIPTION OF THE PREFERRED EMBODIMENTS

Exemplary embodiments of the present invention will be explained below in detail with reference to the accompanying drawings. A summary and features of an index creating apparatus according to a first embodiment of the present invention, a configuration of the index creating apparatus according to the first embodiment, the flow of an index creation control process according to the first embodiment, an example of a screen output according to the first embodiment, and effects of the first embodiment will be explained in that order. The first embodiment is followed by explanations of index creating apparatuses according to second and third embodiments of the present invention in that order, and lastly, other embodiments of the present invention will be explained.

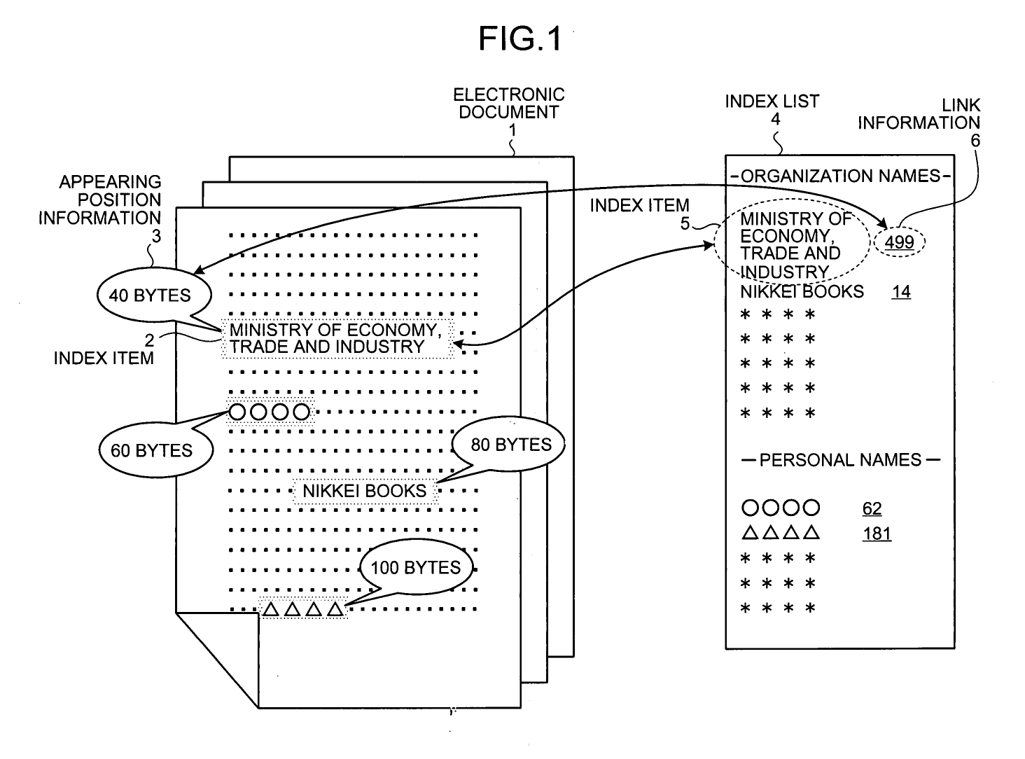

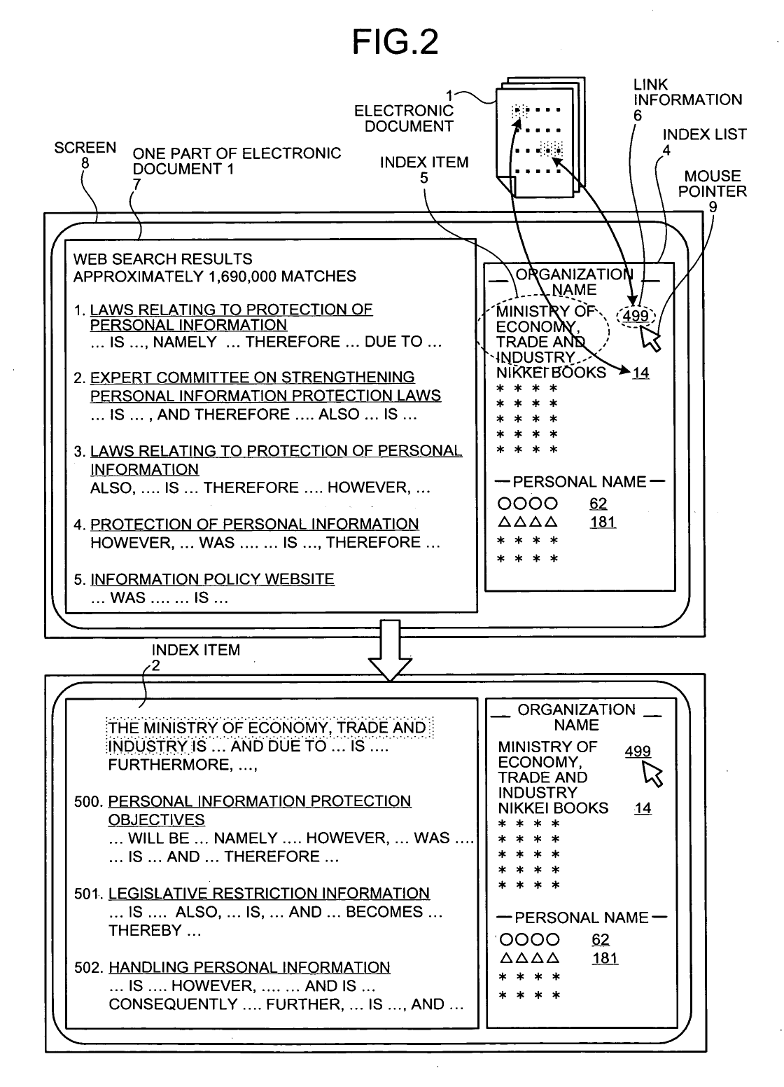

FIGS. 1 and 2 are explanatory diagrams of the summary and features of the index creating apparatus according to the first embodiment.

The index creating apparatus creates an index from an electronic document including, for example, web search results, and displays the index on a display unit. Its main feature is that the index creating apparatus enables a user to speedily ascertain the locations of index items in the electronic document.

This main feature will be explained briefly. The index creating apparatus refers to an electronic dictionary that defines a plurality of terms (for example, an organization-name dictionary having stored a plurality of organization names therein), and extracts index items that form an index from the electronic document together with appearing position information that identifies the locations of those index items (for example, the number of bytes from the head of the electronic document).

As a specific example, in FIG. 1, the index creating apparatus refers to an organization-name dictionary and extracts index items 2 of ‘Ministry of Economy, Trade and Industry (hereinafter, “METI”)’ and ‘Nikkei Books’ from an electronic document 1, together with appearing position information 3 of ‘40 bytes’ and ‘80 bytes’.

From the appearing position information, the index creating apparatus creates link information using the appearing positions of the extracted index items in the electronic document as links, attaches the link information to the respective index items, and arranges the index items that the link information has been attached to in an index list.

As a specific example, as shown in FIG. 1, the index creating apparatus creates link information 6 of ‘499 (underlined)’ using the appearing position of the index item 2 ‘METI’ as its link by embedding the appearing position information 3 of ‘40 bytes’ in a paragraph number of ‘499’ provided for each item in the list of web search results, and creates an index list 4 in which the link information 6 of ‘499 (underlined)’ is arranged on the right of an index item 5 of ‘METI’.

As another example, when similarly creating the index list 4 described by a hypertext markup language (HTML) for the electronic document 1 of the HTML description, based on the appearing position information 3 of ‘40 bytes’, the index creating apparatus embeds a tag <a name=‘xxx’> indicating a link at a position of 40 bytes from the text head of the electronic document 1. In addition, the index creating apparatus embeds a tag <a href=‘xxx’> that forms the link source in the text of the index list 4, and inserts ‘499’ into the tag such that the link information 6 of ‘499 (underlined)’ in the electronic document is displayed in the index list 4. The symbol ‘xxx’ is a unique identifier allocated to each piece of appearing position information.

The index creating apparatus then displays the created index list on the display unit, and, when a predetermined control operation regarding link information is made, immediately displays the appearing location of the predetermined index item in the electronic document on the display unit.

Specifically, as shown in FIG. 2, the index creating apparatus displays the index list 4 and one part 7 of the electronic document 1 on a screen 8. If, for example, a user clicks on the position of a mouse pointer 9 with a mouse in regard to the link information 6 ‘499 (underlined)’ attached to the index item 5 ‘METI’, the index creating apparatus displays the location where the index item 2 ‘METI’ appears in the electronic document 1.

By using this main feature, the index creating apparatus according to the first embodiment enables the user to speedily ascertain the location of an index item in the electronic document.

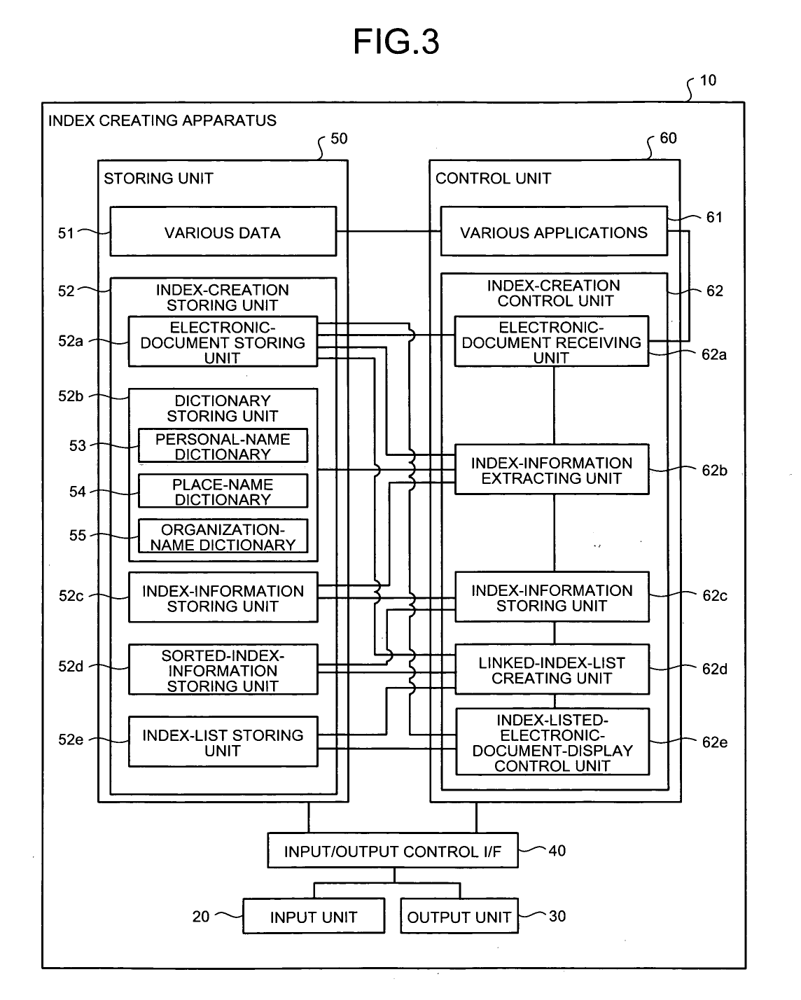

FIG. 3 is a block diagram of the configuration of an index creating apparatus 10 according to the first embodiment. As shown in FIG. 3, the index creating apparatus 10 includes an input unit 20, an output unit 30, an input/output control interface (I/F) 40, a storing unit 50, and a control unit 60.

The input unit 20 receives various types of information to be input, and includes a keyboard, a mouse, and the like. For example, a location in the electronic document from link information in the index list can be accessed by clicking on with the mouse. A display of the appearing position information 3 explained below realizes a pointing device function in cooperation with the mouse.

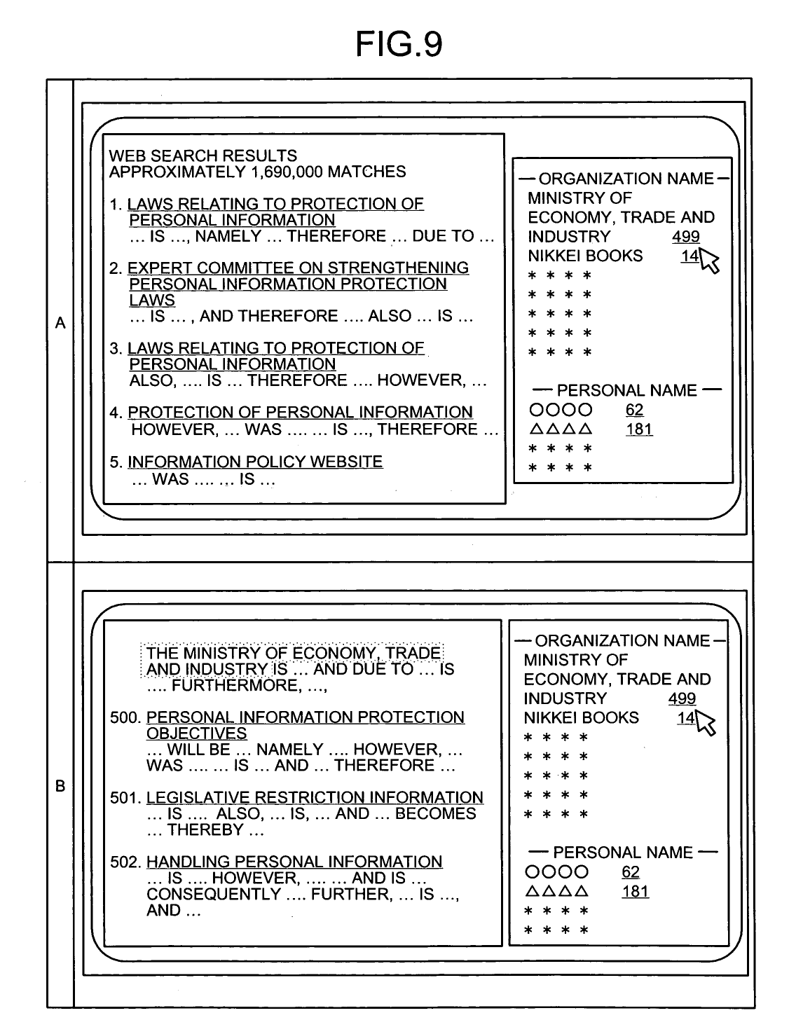

The output unit 30 outputs various types of information, and includes a display. For example, the output unit 30 outputs and displays an electronic document, an index list, or the like (see A in FIG. 9). Also, for example, when it is clicked with a mouse in regard to link information in the index list, the output unit 30 outputs and displays the location of the link in the electronic document (see B in FIG. 9).

The input/output control I/F 40 controls data transfer between the input unit 20, the output unit 30, the storing unit 50, and the control unit 60 explained below.

The storing unit 50 stores data and programs required in various processes executed by the control unit 60. Of particular relevance to the invention, in addition to various data 51 used in various applications 61, the storing unit 50 includes an index-creation storing unit 52. The index-creation storing unit 52 stores data required in various processes executed by an index-creation control unit 62 explained below, and includes an electronic-document storing unit 52a, a dictionary storing unit 52b, an index-information storing unit 52c, a sorted-index-information storing unit 52d, and an index-list storing unit 52e.

The electronic-document storing unit 52a stores an electronic document, and specifically, it receives and stores an electronic document output by an electronic-document receiving unit 62a explained below. The electronic document stored in the electronic-document storing unit 52a is an HTML document, for example.

The dictionary storing unit 52b stores an electronic dictionary that defines a plurality of terms, and specifically, it includes a personal-name dictionary 53 that stores names of persons, a place-name dictionary 54 that stores names of places, and an organization-name dictionary 55 that stores names of organizations. For example, the organization-name dictionary 55 of the dictionary storing unit 52b stores organization names such as ‘METI’ and ‘Nikkei Books’.

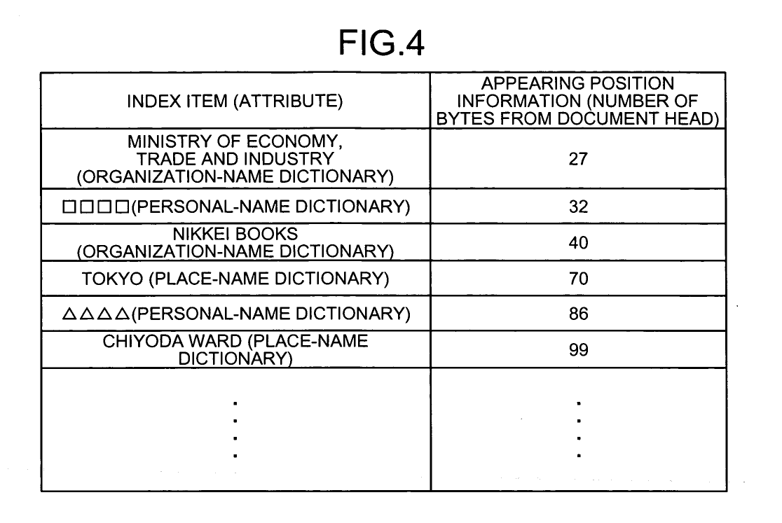

The index-information storing unit 52c stores index information required for creating an index list (for example, index items and appearing position information of index items). Specifically, the index-information storing unit 52c receives an index item output from an index-information extracting unit 62b described below, and appearing position information of the index item in the electronic document (for example, the number of bytes from the head of the electronic document), and stores them corresponding to each other. For example, as shown in FIG. 4, the index-information storing unit 52c stores appearing position information of ‘27’ in correspondence with the index item ‘METI’ (Organization-name dictionary)’ that dictionary attribute information is attached to. FIG. 4 is an example of information stored in an index-information storing unit.

The sorted-index-information storing unit 52d stores index information in a manner similar to the index-information storing unit 52c. Specifically, the sorted-index-information storing unit 52d receives and stores index information, obtained when an index-information sorting unit 62c (explained below) sorts index information stored in the index-creation storing unit 52, from the index-information sorting unit 62c. A linked-index-list creating unit 62d (explained below) can create an orderly item-based index list by sequentially reading the index information stored in the sorted-index-information storing unit 52d.

The index-list storing unit 52e stores index-list data, and specifically, it receives and stores index-list data output from the linked-index-list creating unit 62d explained below. Index-list data includes text information, and link information, layout information used in displaying on the display unit, or the like.

The control unit 60 is a processor that includes a control program such as an operating system (OS), programs defining various process procedures, and an internal memory for storing required data, and executes various processes in correspondence therewith. Of particular relevance to the invention, the control unit 60 includes the various applications 61 and the index-creation control unit 62.

The various applications 61 are application software executed for their respective jobs and usages. As a specific example, the various applications 61 include web browser software and output an HTML document or the like, namely an electronic document including a list of web search results, to the electronic-document receiving unit 62a.

As shown in FIG. 3, the index-creation control unit 62 includes the electronic-document receiving unit 62a, the index-information extracting unit 62b, the index-information sorting unit 62c, the linked-index-list creating unit 62d, and an index-listed-electronic-document-display control unit 62e. The index-information extracting unit 62b corresponds to an ‘index item extracting procedure’ of the appended claims. Similarly, the index-information sorting unit 62c corresponds to an ‘index item sorting procedure’, and the linked-index-list creating unit 62d corresponds to an ‘index list creating procedure’ of the appended claims.

The electronic-document receiving unit 62a receives an electronic document. Specifically, when the electronic-document receiving unit 62a receives an electronic document output from the various applications 61, it stores the electronic document in the electronic-document storing unit 52a, and outputs a control signal issuing a command to extract index information to the index-information extracting unit 62b.

The index-information extracting unit 62b extracts the index items that are included in the index from the electronic document, together with their appearing position information. Specifically, when the index-information extracting unit 62b receives the control signal from the electronic-document receiving unit 62a, it reads the electronic document from the electronic-document storing unit 52a and, while referring to the dictionary storing unit 52b, extracts terms defined in the personal-name dictionary 53, the place-name dictionary 54, and the organization-name dictionary 55, as index items from the electronic document, together with their appearing position information. The index-information extracting unit 62b then stores the terms and information in the index-information storing unit 52c, and outputs a control signal issuing a command to sort the index information to the index-information sorting unit 62c. The index-information extracting unit 62b attaches attribute information of each dictionary to the index items and stores them in the index-information storing unit 52c; thereby the index-information sorting unit 62c described below sorts the index items according to the dictionary types.

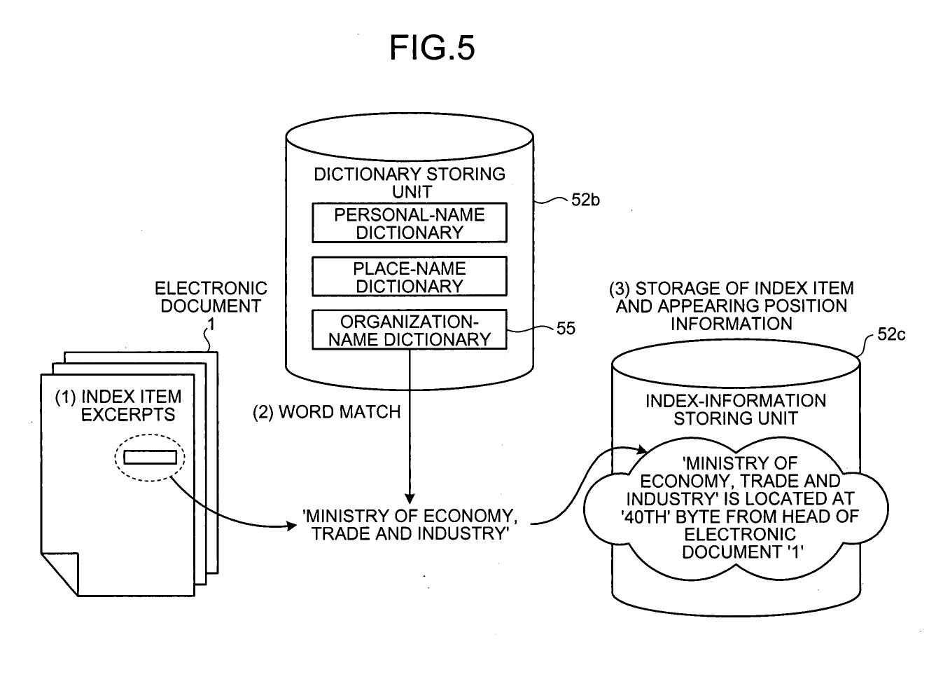

A specific example of a process performed by the index-information extracting unit 62b will be explained. In FIG. 5, the index-information extracting unit 62b reads the electronic document 1, and uses morphological analysis or the like to excerpt an index item of ‘METI’ (see (1) in FIG. 5). The index-information extracting unit 62b then refers to the dictionaries in the dictionary storing unit 52b and, when ‘METI’ is listed in the organization-name dictionary (see (2) in FIG. 5), the index-information extracting unit 62b extracts the index item ‘METI’ from the electronic document 1, and stores the index item with attached attribute information of the organization-name dictionary in the index-information storing unit 52c, together with its appearing position information of ‘40 bytes’ (see (3) in FIG. 3). FIG. 5 is an explanatory diagram of the index-information extracting unit 62b.

The index-information sorting unit 62c sorts the index information stored by the index-information storing unit 52c according to a predetermined reference. Specifically, when the index-information sorting unit 62c receives the control signal from the index-information extracting unit 62b, it reads the index information from the index-information storing unit 52c and sorts the index items for each dictionary type according to the dictionary attribute information attached to them. It then stores the items and information in the sorted-index-information storing unit 52d in that order, and outputs a control signal issuing a command to create an index list to the linked-index-list creating unit 62d. The appearing position information corresponding to the index items is similarly sorted according to the sorting of the index items, and stored in the sorted-index-information storing unit 52d according to the original correspondence.

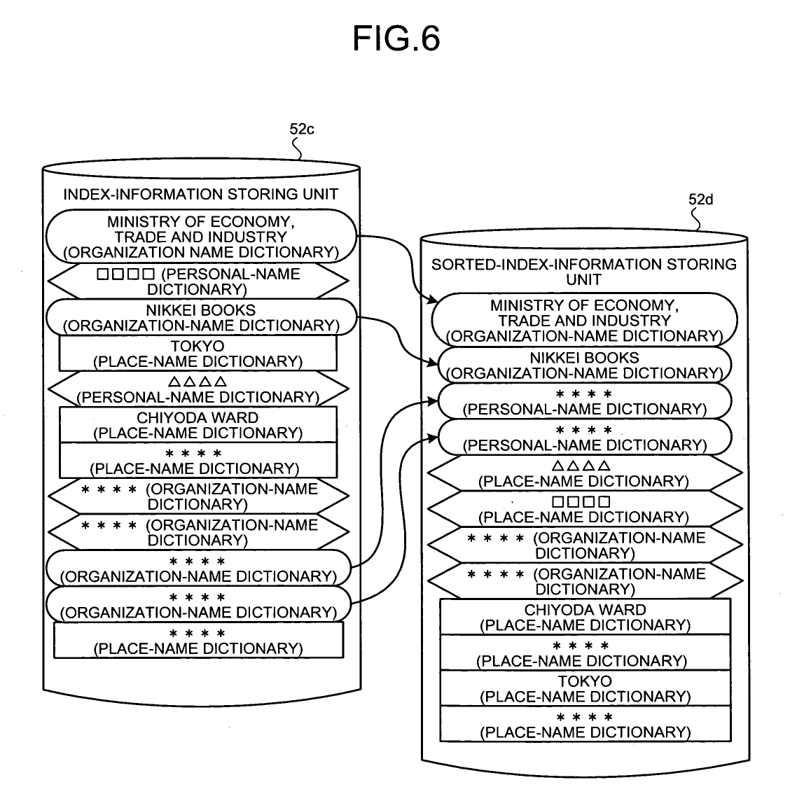

A specific example of a process performed by the index-information sorting unit 62c will be explained. As shown in FIG. 6, the index-information sorting unit 62c sorts index information, which the index-information extracting unit 62b arranges in the order it is stored in the index-information storing unit 52c, for each of the index information extracted from the organization-name dictionary, the index information extracted from the personal-name dictionary, and the index information extracted from the place-name dictionary, and stores these in the sorted-index-information storing unit 52d. FIG. 6 is an explanatory diagram of the index-information sorting unit 62c. The index can be sorted using read information, appearing frequency, a length sequence of letters, a text code sequence, and the like, as a predetermined reference for sorting.

The linked-index-list creating unit 62d creates link information including appearing-position information of the index items in the electronic document as a link, attaches this link information to the index items, and creates an index list by arranging the index items that the link information has been attached to. Specifically, when the linked-index-list creating unit 62d receives the control signal from the index-information sorting unit 62c, it reads the index information stored in the sorted-index-information storing unit 52d sequentially, creates index items for an index list according to the index items, creates link information to the electronic document stored in the electronic-document storing unit 52a according to the appearing position information, creates an index list by partitioning the index items of the index list according to the dictionary attribute information attached to them, and stores data of the index list in the index-list storing unit 52e. In addition, the linked-index-list creating unit 62d outputs a control signal issuing a command to output and display the index list and the electronic document to the index-listed-electronic-document-display control unit 62e.

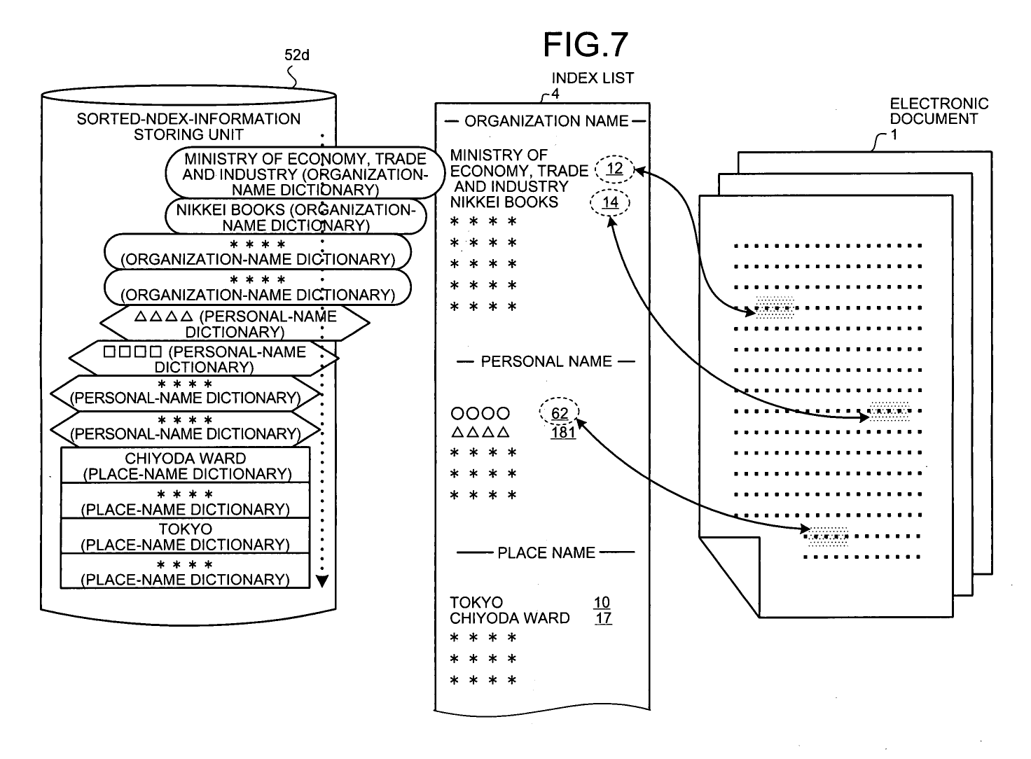

A specific example of a process performed by the linked-index-list creating unit 62d will be explained. In FIG. 7, when the linked-index-list creating unit 62d reads index information whose index item in the sorted-index-information storing unit 52d is ‘METI’, the linked-index-list creating unit 62d creates an index item of the index list 4 for ‘METI’, and uses the appearing position information to search for locations where ‘METI’ is written in the electronic document. In addition, the linked-index-list creating unit 62d reads the paragraph number ‘12’ from the electronic-document storing unit 52a and embeds the appearing position information in this paragraph number ‘12’, thereby creating link information of ‘12 (underlined)’, which the linked-index-list creating unit 62d attaches to the right of ‘METI’. FIG. 7 is an explanatory diagram of creation of a linked index list.

The index-listed-electronic-document-display control unit 62edisplays the index list and the electronic document on the display unit. Specifically, when the index-listed-electronic-document-display control unit 62e receives a control signal from the linked-index-list creating unit 62d, it reads the electronic document from the electronic-document storing unit 52a, reads the data of the index list from the index-list storing unit 52e, and displays the electronic document and the index on the screen by outputting them to the output unit 30 (see FIG. 9).

The index creating apparatus 10 can be realized by incorporating the functions of the electronic-document receiving unit 62a, the index-information extracting unit 62b, the index-information sorting unit 62c, the linked-index-list creating unit 62d, and the index-listed-electronic-document-display control unit 62ein an information processing apparatus such as a conventional personal computer, a work station, a mobile telephone, a personal handyphone system (PHS) terminal, a mobile communication terminal, and a personal digital assistant (PDA).

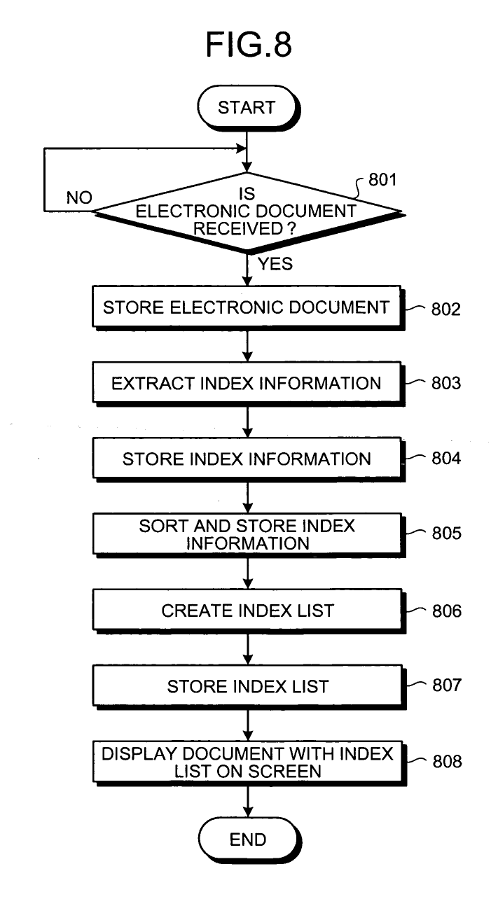

FIG. 8 is a flowchart of a process performed by the index-creation control unit 62 of the index creating apparatus 10 according to the first embodiment.

As shown in FIG. 8, when the electronic-document receiving unit 62a receives an electronic document from the various applications 61 (step S801: Yes), the index-creation control unit 62 stores the electronic document in the electronic-document receiving unit 62a (step S802).

The index-creation control unit 62 uses the index-information extracting unit 62b to extract index information from the electronic document stored in the electronic-document storing unit 52a (step S803), and stores the index information in the index-information storing unit 52c (step S804).

The index-creation control unit 62 stores the index information in the sorted-index-information storing unit 52d while sorting the index information stored in the index-information storing unit 52c according to a predetermined reference by the index-information sorting unit 62c (step S805).

The index-creation control unit 62 uses the linked-index-list creating unit 62d to read index information stored in the sorted-index-information storing unit 52d sequentially, creates an index list of link information to the electronic document stored in the electronic-document storing unit 52a (step S806), and stores data of the index list in the index-list storing unit 52e (step S807).

Lastly, the index-creation control unit 62 uses the index-listed-electronic-document-display control unit 62e to read the electronic document from the electronic-document storing unit 52a, reads the data of the index list from the index-list storing unit 52e, outputs the electronic document and the index list to the output unit 30, and displays them on the display (step S808), thereby the process ends.

FIG. 9 is an example of a screen of the output unit 30. For example, when the user executes browser software that reads an HTML document, searches a search site or the like, and obtains a large quantity of search results, the index creating apparatus 10 creates an index list for the HTML document of the search results, and displays this index list with the electronic documents of the search results on the display as shown in A in FIG. 9.

When a user clicks on, for example, link information ‘499 (underlined)’ with a mouse, as shown in B in FIG. 9, the index creating apparatus 10 displays the location of an electronic document of the link.

As described above according to the first embodiment, index items for an index of an HTML document including a list of search results are extracted from the HTML document together with the number of bytes from the head, link information that uses appearing positions of the extracted index items in the HTML document as its links is created from the byte numbers and attached to each index item, and the index items that the link information has been attached to are arranged into an index list. Therefore, for example, if a user clicks on link information included in a predetermined index item of the index list displayed on the display, the location where the predetermined index item appears in the HTML document is immediately displayed on the display, enabling the user to speedily ascertain the location of the index item.

Furthermore, according to the first embodiment, the extracted index items are sorted according to dictionaries, and an index list of the sorted index items is created. Accordingly, by displaying this orderly item-based index list, the user can effectively ascertain the content of the HTML document.

Furthermore, according to the first embodiment, by referring to the dictionaries, terms defined in the dictionaries are extracted from the HTML document as index items. Therefore, an index list citing reliable terms defined by the dictionaries can be created.

While in the first embodiment, terms defined in the dictionaries are extracted from the electronic document as index items, a second embodiment of the present invention describes a method of extracting specific expressions without referring to dictionaries.

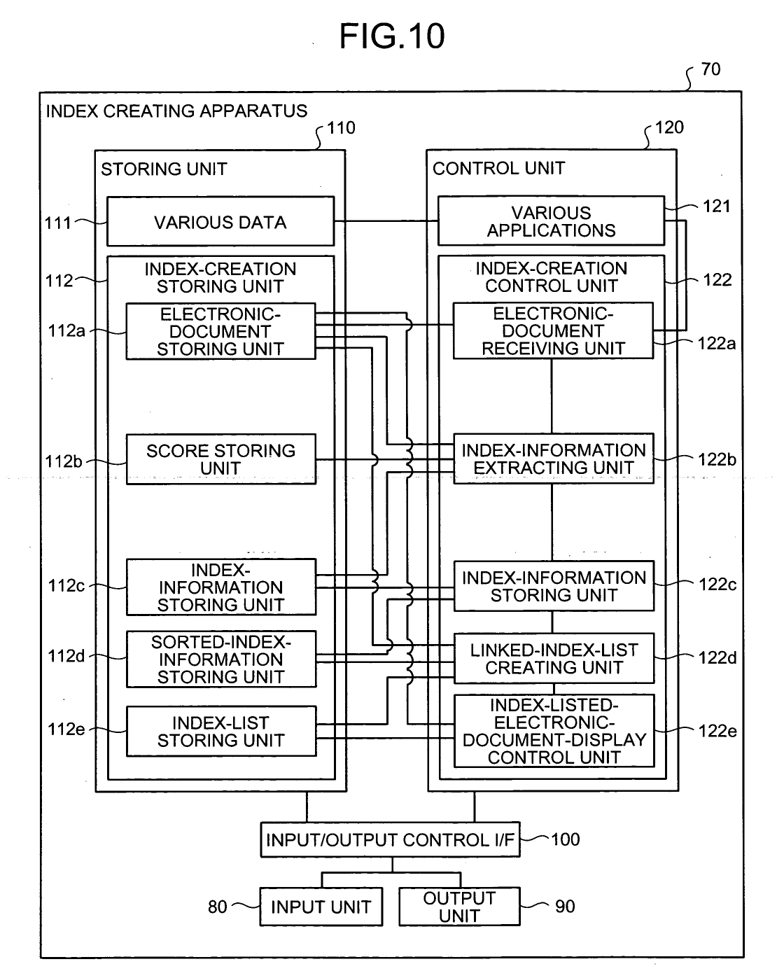

FIG. 10 is a block diagram of a configuration of an index creating apparatus 70 according to the second embodiment. As shown in FIG. 10, as in the first embodiment, the index creating apparatus 70 includes an input unit 80, an output unit 90, an input/output control I/F 100, a storing unit 110, and a control unit 120. The storing unit 110 includes various data 111 and an index-creation storing unit 112. The index-creation storing unit 112 includes an electronic-document storing unit 112a, a score storing unit 112b, an index-information storing unit 112c, a sorted-index-information storing unit 112d, and an index-list storing unit 112e. The control unit 120 includes various applications 121 and an index-creation control unit 122. The index-creation control unit 122 includes an electronic-document receiving unit 122a, an index-information extracting unit 122b, an index-information sorting unit 122c, a linked-index-list creating unit 122d, and an index-listed-electronic-document-display control unit 122e.

The input unit 80, the output unit 90, the input/output control I/F 100, the storing unit 110, the various data 111, the index-creation storing unit 112, the electronic-document storing unit 112a, the index-information storing unit 112c, the sorted-index-information storing unit 112d, the index-list storing unit 112e, the control unit 120, the various applications 121, the index-creation control unit 122, and the electronic-document receiving unit 122a perform the same operations as the first embodiment, and therefore explanations thereof are omitted. The score storing unit 112b and the index-information extracting unit 122b will be explained below. Since the basic process of the index-creation control unit 122 is the same as that described with reference to FIG. 8, explanation thereof is omitted.

The score storing unit 112b stores given scores of the index items in regard to each attribute of specific expressions. Specifically, it receives index items partitioned by the index-information extracting unit 122b explained below and scores given to the index items for each attribute (personal names, place names, or the like) of specific expressions, and stores the items in correspondence together. A score is a measure indicating the possibility of an attribute of a specific expression, the higher the score, the higher the possibility that the specific expression possess that attribute. Scores are determined by context and pattern referencing. For example, an index item including a suffix such as ‘Mister’ has a high possibility of being a ‘personal name’, which is one of the attributes of specific expressions, and is therefore given a high score for ‘personal name’.

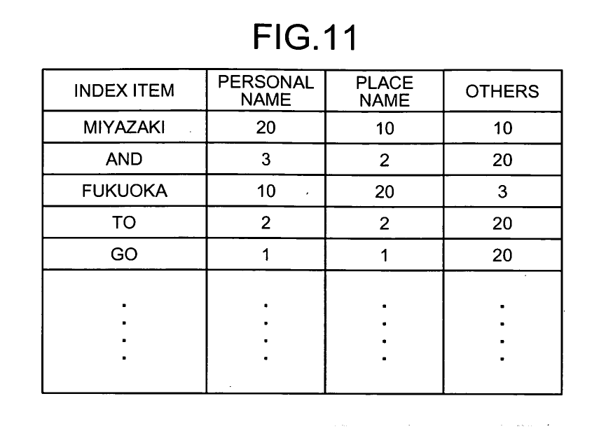

In an example shown in FIG. 11, for an index item ‘Miyazaki’, the score storing unit 112b stores a personal name score of ‘20’, a place name score of ‘10’, and an other score of ‘10’. FIG. 11 is an example of information stored by the score storing unit 112b.

The index-information extracting unit 122b gives a score for each attribute of specific expressions in regard to index items in the electronic document, and extracts the index items according to the attributes of specific expressions with the highest scores. Specifically, when it receives a control signal issuing a command to extract index information from the electronic-document receiving unit 122a, the index-information extracting unit 122b reads the electronic document from the electronic-document storing unit 112a, uses morphological analysis or the like to excerpt the index items from the head, gives a score for each attribute of specific expressions to each index item based on context and pattern referencing, and temporarily stores the index items in correspondence with the scores for each attribute of specific expressions in the score storing unit 112b. When extracting index items from the electronic document, the index-information extracting unit 122b attaches attribute information of specific expressions with the highest score to the index items, extracts their appearing position information, and stores these in the index-information storing unit 112c.

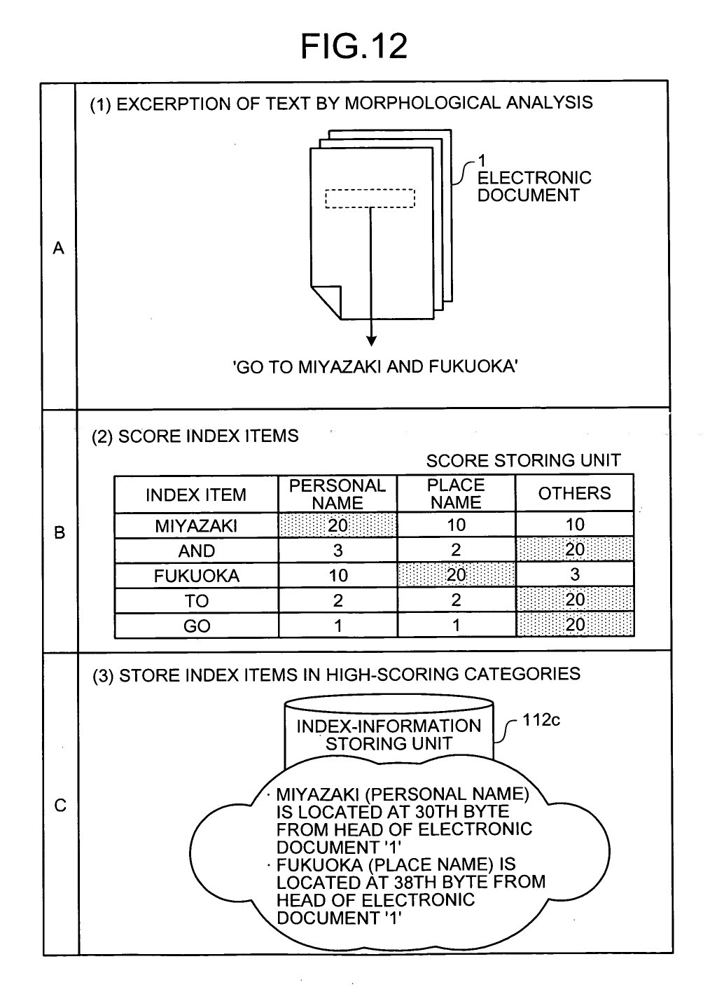

A specific example of a process performed by the index-information extracting unit 122b will be explained next. As shown in FIG. 12, the index-information extracting unit 122b performs morphological analysis to a divide a text of ‘Go to Miyazaki and Fukuoka’ in an electronic document into five words, namely ‘Go’, ‘to’, ‘Miyazaki’, ‘and’, and ‘Fukuoka’, and excerpts each of these words as an index item (see A in FIG. 12).

Based on context and pattern referencing, the index-information extracting unit 122b gives the index item ‘Miyazaki’ a personal name score of, for example, ‘20’, a place name score of ‘10’, and an other score of ‘10’ (see B in FIG. 12) (for details on a method of extracting the index item, see, for example, Masayuki Asahara and Yuji Matsumoto, “Japanese named entity extraction with redundant morphological analysis”, In Pr oc. Human Language Technology and North American Chapter of Association for Comp utational Linguistics (HLT-NAACL), pp. 8-15, May 2003).

The index-information extracting unit 122b determines that the highest scoring attribute of specific expressions for the index item ‘Miyazaki’ is personal name (the shaded cell in the table, of B in FIG. 12). When extracting the index item ‘Miyazaki’ from the electronic document, the index-information extracting unit 122b appends specific expression attribute information of ‘personal name’ and extracts appearing position information of ‘30’. It stores these in the index-information storing unit 112c (see C in FIG. 12). FIG. 12 is an explanatory diagram of the index-information extracting unit 122b.

In addition to personal names and place names, the attribute information of specific expressions that the index-information extracting unit 122b appends to the index items can include organization names, proper names, expressions of dates, times, monetary prices, ratios, and the like. The index-information sorting unit 122c sorts the index information based on the attribute information of specific expressions given to the index items. Index items to which attribute information of specific expressions of ‘other’ is appended can be extracted as they are, or excluded from the extraction.

The index-information sorting unit 122c sorts the index information stored by the index-information sorting unit 122c according to a predetermined reference. Specifically, differently from the first embodiment, the index-information sorting unit 122c sorts the index items based on the attribute information of specific expressions given to them by the index-information extracting unit 122b, and stores them in the sorted-index-information storing unit 112d. That is, in the example described above, it sorts the index items based on attribute information of specific expressions such as personal names and place names, and stores them in the sorted-index-information storing unit 112d.

The linked-index-list creating unit 122d creates an index list by arranging index items that link information is attached to. Specifically, differently from the first embodiment, the linked-index-list creating unit 122d creates partitions of an index list according to attribute information of specific expressions attached to the index items. That is, in the above example, the linked-index-list creating unit 122d creates an index list that includes partitions such as ‘personal names’ and ‘place names’.

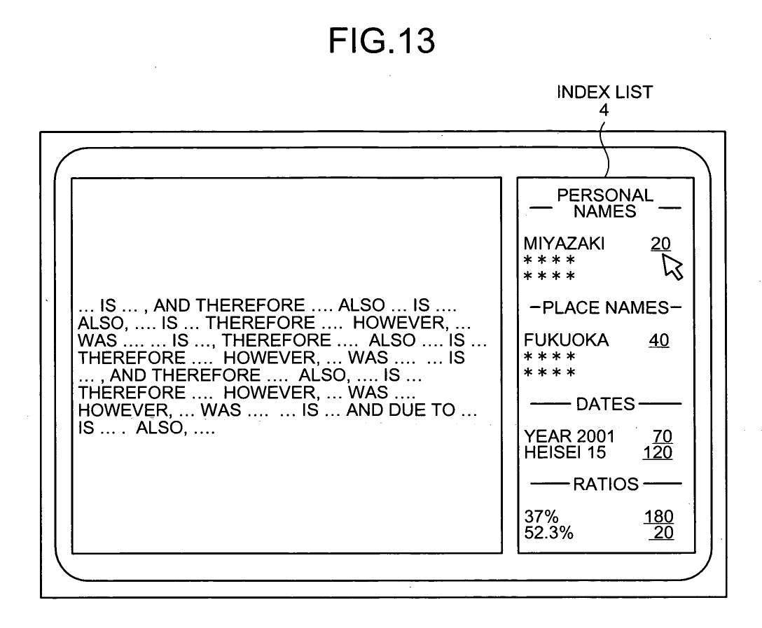

The index-listed-electronic-document-display control unit 122e displays the index list and the electronic document on a display unit. Specifically, differently from the first embodiment, the index-listed-electronic-document-display control unit 122e displays an index list that includes partitions created by the linked-index-list creating unit 122d according to the attribute information of specific expressions attached to the index items. FIG. 13 is an example of a screen of an output unit according to the second embodiment. As shown in FIG. 13, the index list 4 is displayed in partitions created according to the attribute information of specific expressions.

As described above, according to the second embodiment, after giving scores to each attribute of specific expressions of index items in an electronic document, the index items with the highest scoring attribute information of specific expressions are extracted. Therefore, it is possible to create an index list citing flexible terms based on extraction of specific expressions, without being influenced by dictionaries.

Furthermore, according to the second embodiment, the index items are sorted according to attributes (personal names, place names, or the like) of specific expressions of index items in an electronic document. Therefore, by displaying the orderly item-based index list, the user can effectively ascertain the content of the document.

While in the second embodiment, scores given for each attribute of specific expressions are used unchanged, a third embodiment of the present invention describes a method of changing the attribute information of specific expressions given to the index items by changing the scores based on predetermined conditions.

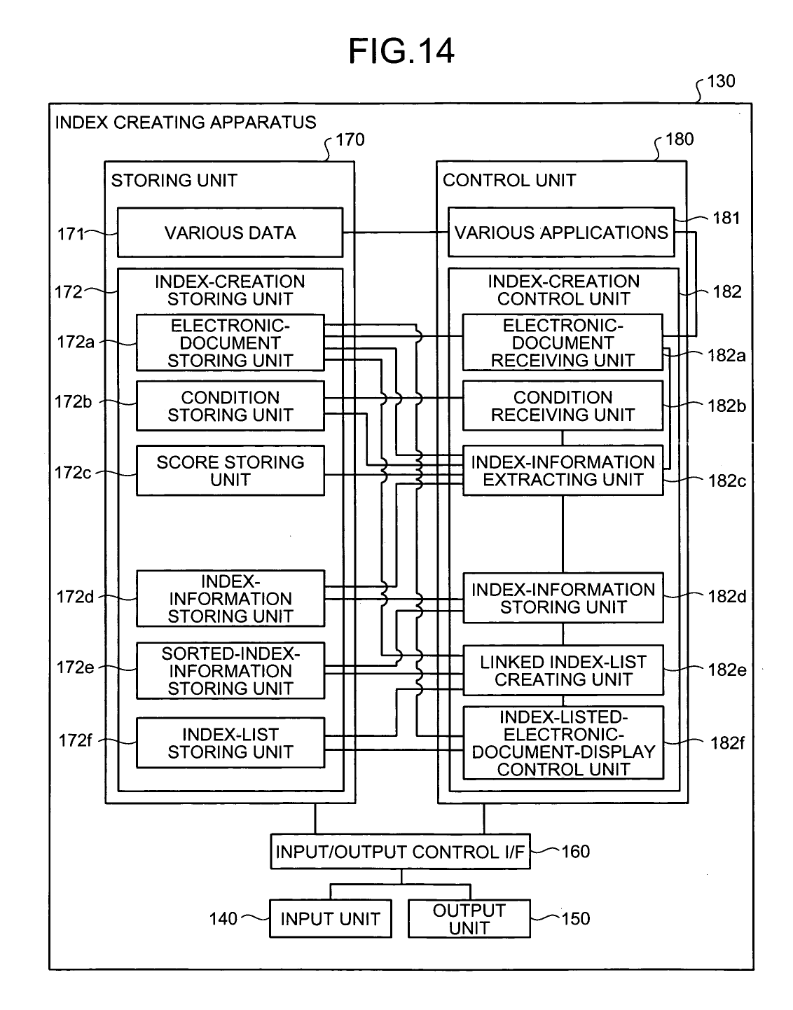

FIG. 14 is a block diagram of a configuration of an index creating apparatus 130 according to the third embodiment. Similarly to the second embodiment, as shown in FIG. 13, the index creating apparatus 130 includes an input unit 140, an output unit 150, an input/output control I/F 160, a storing unit 170, and a control unit 180. The storing unit 170 includes various data 171 and an index-creation storing unit 172. The index-creation storing unit 172 includes an electronic-document storing unit 172a, a condition storing unit 172b, a score storing unit 172c, an index-information storing unit 172d, a sorted-index-information storing unit 172e, and an index-list storing unit 172f. The control unit 180 includes various applications 181 and an index-creation control unit 182. The index-creation control unit 182 includes an electronic-document receiving unit 182a, a condition receiving unit 182b, an index-information extracting unit 182c, an index-information sorting unit 182d, a linked-index-list creating unit 182e, and an index-listed-electronic-document-display control unit 182f.

The input unit 140, the output unit 150, the input/output control I/F 160, the storing unit 170, the various data 171, the index-creation storing unit 172, the electronic-document storing unit 172a, the score storing unit 172c, the index-information storing unit 172d, the sorted-index-information storing unit 172e, the index-list storing unit 172f, the control unit 180, the various applications 181, the index-creation control unit 182, the electronic-document receiving unit 182a, the index-information sorting unit 182d, the linked-index-list creating unit 182e, and the index-listed-electronic-document-display control unit 182f have the same operations as those in the second embodiment, and will not be further explained. The condition storing unit 172b, the condition receiving unit 182b, and the index-information extracting unit 182c are explained below. Since the basic process of the index-creation control unit is the same as that described in FIG. 8, explanation thereof is omitted.

The condition storing unit 172b stores weight conditions in the score for each attribute of specific expressions. Specifically, the condition storing unit 172b stores information relating to weights output from the condition receiving unit 182b explained below. For example, the condition storing unit 172b stores conditions such as ‘twice the score for personal name’ and ‘five times the score for place name’.

The condition receiving unit 182b receives weight conditions in the score for each attribute of specific expressions. Specifically, the condition receiving unit 182b receives information relating to weights received by the input unit 140 at any given time from the user (‘twice the score for personal name, five times the score for place name’ or the like), and stores the information in the condition storing unit 172b.

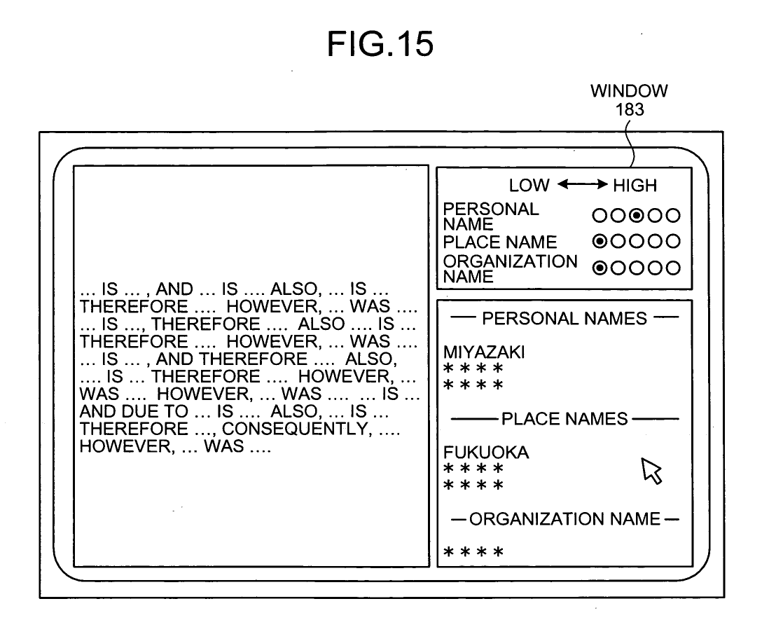

FIG. 15 is an example of a screen of an output unit according to the third embodiment. As shown in FIG. 15, the condition receiving unit 182b receives information relating to weights of attributes of specific expressions from the user via a window 183.

The index-information extracting unit 182c gives a score for each attribute of specific expressions of index items in an electronic document based on the weight conditions received by the condition receiving unit 182b.

Specifically, as in the second embodiment, when the index-information extracting unit 182c receives a control signal issuing a command to extract index information from the electronic-document receiving unit 182a, it reads the electronic document from the electronic-document storing unit 172a, uses morphological analysis or the like to excerpt the index items from the head, gives a score for each attribute of specific expressions to each index item based on context and pattern referencing, and temporarily stores the index items in correspondence with the scores for each attribute of specific expressions in the score storing unit 172c.

Differently from the second embodiment, the index-information extracting unit 182c reads the information relating to the weights from the condition storing unit 172b, and changes the scores in the score storing unit 172c based on that information.

When extracting index items from the electronic document, as in the second embodiment, the index-information extracting unit 182c attaches attribute information of specific expressions with the highest score to the index items, extracts their appearing position information, and stores these in the index-information storing unit 112c.

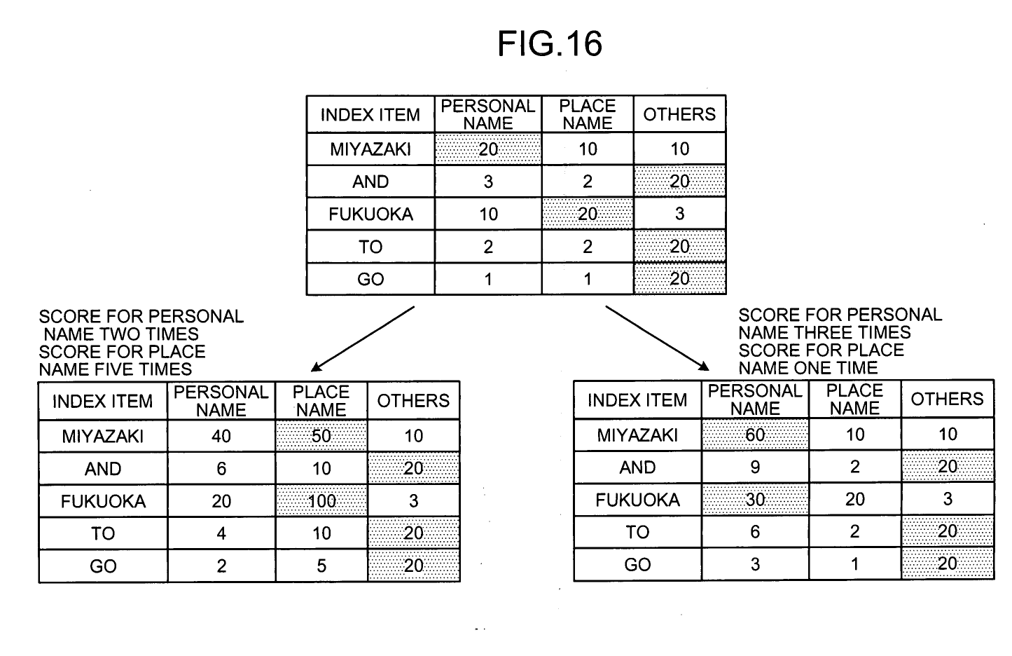

A specific example of a process performed by the index-information extracting unit 182c will be explained. As shown in FIG. 16, while the highest score of index item ‘Miyazaki’ before weighting is its score for personal name, after implementing the weight condition of ‘twice the score for personal name, five times the score for place name’, its place name score becomes the highest. As a result, in contrast to a case without weights, the index-information extracting unit 182c attaches attribute information of specific expression for place name to the index item ‘Miyazaki’ when extracting it. FIG. 16 is an explanatory diagram of changes in attributes of specific expressions due to weighting.

As described above, according to the third embodiment, weight conditions in scores for each attribute of specific expressions are received and scores are given for each attribute of specific expressions of an index item in an electronic document based on these weight conditions. Therefore, it is possible to freely select which attribute of specific expressions (personal name, place name, or the like) is weighted. Accordingly, it is possible to, for example, create index lists centered on personal names, place names or the like, thereby creating index lists flexibly.

While an index creating apparatus of the first to third embodiments is described above, the invention can be embodied in a various different aspects in addition to those of the above embodiments. As an index creating apparatus according to a fourth embodiment of the present invention, different examples will be separately explained below.

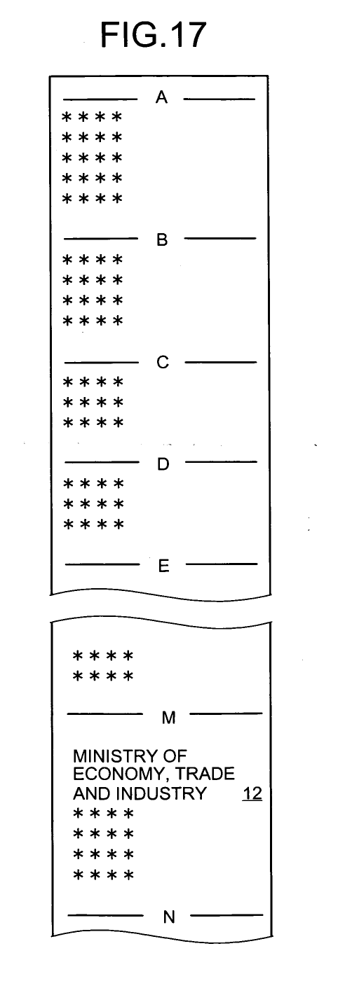

While in the first to third embodiments, the index-information sorting unit of the index creating apparatus sorts the index information according to attributes given to the index items, the present invention is not limited thereto. As shown by way of example in FIG. 17, the index information can be sorted alphabetically according to the titles of the index items (in this case, ‘METI’ is sorted with items starting with ‘M’). FIG. 17 is an example of a method of sorting index items.

The index information can also be sorted according to the appearing frequency of the index items in the electronic document, or according to their usage frequency based on search terms obtained from a log of a search site. These standards for sorting can be combined, by, for example, sorting by attributes and then sorting alphabetically.

Since the extracted index items are sorted according to one or a plurality of appearing frequency, search usage frequency, alphabetical reading, and attributes, an orderly item-based index list can be displayed to the user. Therefore, the user can effectively ascertain the content of the document.

While the first embodiment describes an example where web search results of an HTML document are used as an electronic document, the present invention is not limited thereto. For example, the electronic document can include a general web page, an electronic book, and the like.

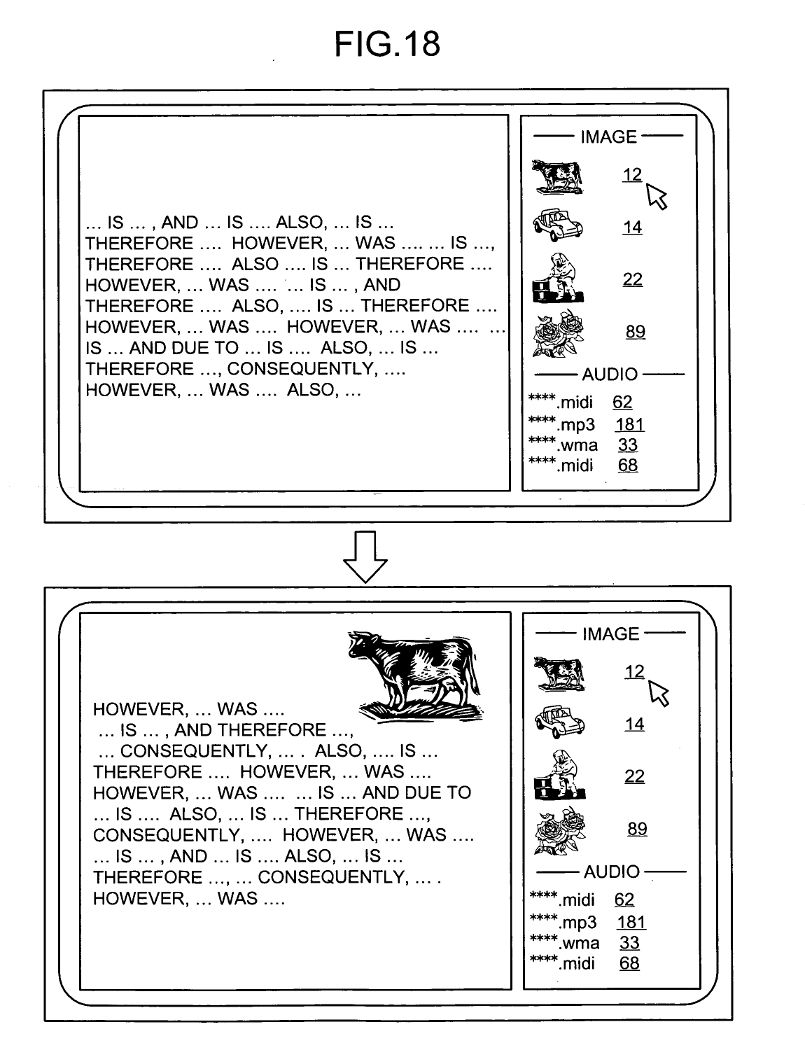

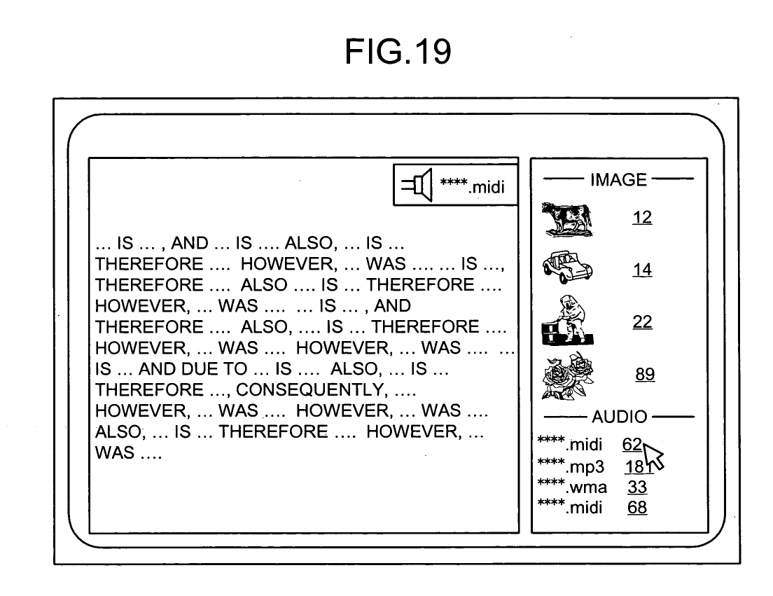

While the first to third embodiments describe a case where the index-information extracting unit extracts text information as index items, the present invention is not limited thereto, and it is possible to extract image files, audio files, and the like as index items. In the case of audio files, as shown in FIGS. 18 and 19, the index creating apparatus displays extensions of the audio files and arranges them as index items of an index list. These files can also be sorted according to their types. In FIGS. 18 and 19, as in the other embodiments, when link information attached to an index item is clicked on with a mouse, the index creating apparatus displays the location of that index item in the electronic document. FIGS. 18 and 19 are examples of screens of an output unit.

Thus, at least one of audio files and image files in an electronic document are extracted as index items, link information using appearing positions of at least one of the audio files and image files in the electronic document as its links is created from appearing position information and attached to the index items, and an index list is created by arranging at least one of the audio files and image files which the link information is attached to. Therefore, not only character information, but also multimedia such as audio files and image files can be extracted as index items.

Furthermore, since the index items are sorted according to attributes of at least one of audio files and image files in the electronic document, the audio files and the image files forming the index items of the index list can be displayed orderly in an item-based list according to their attributes (classification of image or audio, file extension, file size, or the like).

As for information (for example, the examples of screens shown in FIGS. 2 and 9) including the process procedures, control procedures, specific names, and various kinds of data and parameters described in the specification or shown in the drawings, it can be optionally changed unless otherwise specified.

The respective constituent elements of respective devices (the index creating apparatus 10, the index creating apparatus 70, and the index creating apparatus 130) shown in the drawings are functionally conceptual, and physically the same configuration is not always necessary. In other words, the specific mode of dispersion and integration of the respective devices is not limited to the shown ones, and all or a part thereof can be functionally or physically dispersed or integrated in an optional unit, such as integration of the index-information extracting unit 62b and the index-information sorting unit 62c, or integration of the linked-index-list creating unit 62d and the index-listed-electronic-document-display control unit 62e, according to the various kinds of load and the status of use. All or an optional part of the various process functions performed by the respective devices can be realized by a central processing unit (CPU) or a program analyzed and executed by the CPU, or can be realized as hardware by wired logic.

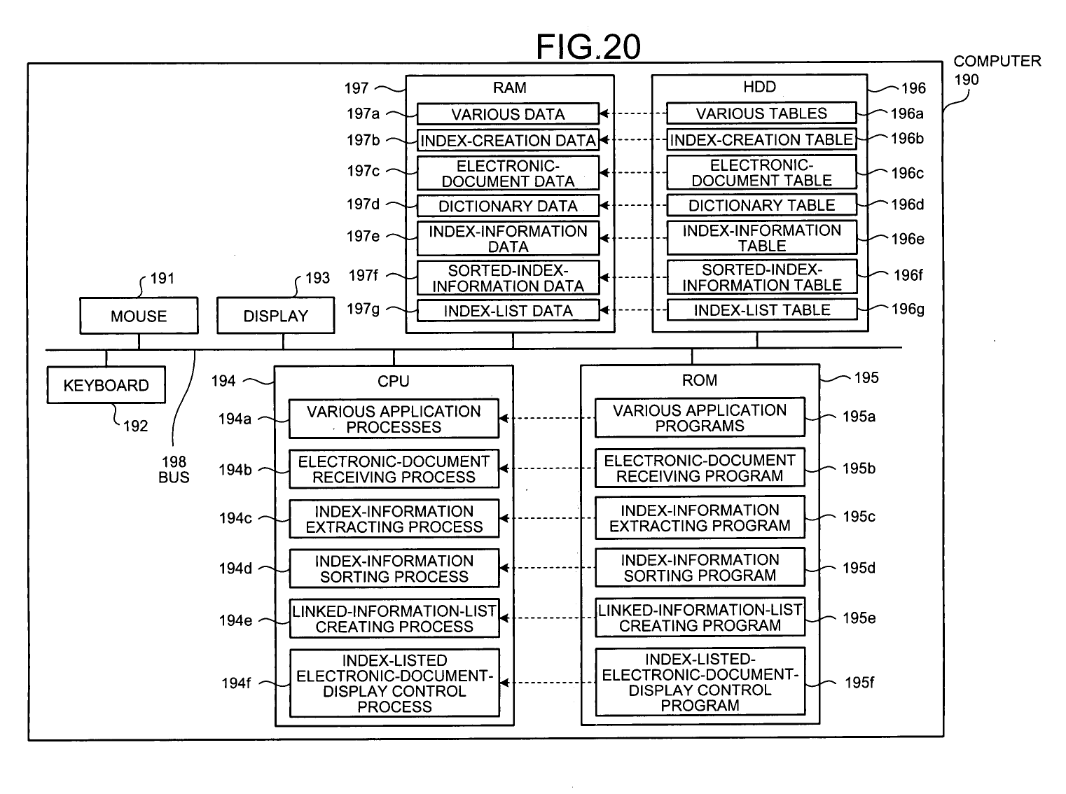

While the first to fourth embodiments have described various processes that are implemented by hardware logic, the present invention is not limited thereto, and the processes can be implemented by making a computer execute a program prepared beforehand. Accordingly, an example will be explained in which an index creating program including the same functions as those of the index creating apparatus 10 described in the first embodiment is executed by a computer. FIG. 20 is a block diagram of a computer that executes an index creating program.

As shown in FIG. 20, a computer 190 functioning as an index creating apparatus includes a mouse 191, a keyboard 192, a display 193, a CPU 194, a read only memory (ROM) 195, a hard disk drive (HDD) 196, and a random access memory (RAM) 197, these being connected by a bus 198 or the like.

An index creating program that realizes the same functions of those of the index creating apparatus 10 described above in the first embodiment (i.e., as shown in FIG. 20, various application programs 195a, an electronic-document receiving program 195b, an index-information extracting program 195c, an index-information sorting program 195d, a linked-information-list creating program 195e, and an index-listed-electronic-document-display control program 195f is stored beforehand in the ROM 195. As with the constituent elements of the index creating apparatus 10 shown in FIG. 3, the programs 195a to 195f can be integrated or dispersed as appropriate.

The CPU 194 executes the programs 195a to 195f by reading them from the ROM 195, thereby, as shown in FIG. 20, the programs 195a to 195f function respectively as various application processes 194a, an electronic-document receiving process 194b, an index-information extracting process 194c, an index-information sorting process 194d, a linked-information-list creating process 194e, and an index-listed-electronic-document-display control process 194f. The processes 194a to 194f correspond to the various applications 61, the electronic-document receiving unit 62a, the index-information extracting unit 62b, the index-information sorting unit 62c, the linked-index-list creating unit 62d, and the index-listed-electronic-document-display control unit 62e.

As shown in FIG. 20, the HDD 196 includes various tables 196a, an index-creation table 196b, an electronic-document table 196c, a dictionary table 196d, an index-information table 196e, a sorted-index-information table 196f, and an index-list table 196g. The various tables 196a, the index-creation table 196b, the electronic-document table 196c, the dictionary table 196d, the index-information table 196e, the sorted-index-information table 196f, and the index-list table 196g correspond respectively to the various data 51, the index-creation storing unit 52, the electronic-document storing unit 52a, the dictionary storing unit 52b, the index-information storing unit 52c, the sorted-index-information storing unit 52d, and the index-list storing unit 52e shown in FIG. 3. From the various tables 196a, the index-creation table 196b, the electronic-document table 196c, the dictionary table 196d, the index-information table 196e, the sorted-index-information table 196f, and the index-list table 196g, the CPU 194 reads various data 197a, index-creation data 197b, electronic-document data 197c, dictionary data 197d, index-information data 197e, sorted index-information data 197f, and index-list data 197g, and stores these data in the RAM 197. The CPU 194 executes operations such as creating an index list and displaying the index list based on the various data 197a, the index-creation data 197b, the electronic-document data 197c, the dictionary data 197d, the index-information data 197e, the sorted index-information data 197f, and the index-list data 197g.

The programs 195a to 195f need not be stored in the ROM 195 from the start. For example, they can be stored in a ‘portable physical medium’ such as a flexible disk (FD), a compact disc read only memory (CD-ROM), a magneto optical (MO) disk, a digital versatile disk (DVD), an integrated circuit (IC) card, a ‘fixed physical medium’ such as an HDD included both inside and outside the computer 190, and ‘another computer (or a server)’ that is connected to the computer 190 via a public line, the Internet, a local area network (LAN), a wide area network (WAN), or the like. The computer 190 can then execute the programs by reading them from the medium.

As describe above, according to an embodiment of the present invention, if the user clicks on link information included in a predetermined index item of the index list displayed on a display unit, the location where the predetermined index item appears in the electronic document is immediately displayed on the display unit, thereby the user can speedily ascertain the location of the index item.

Furthermore, according to an embodiment of the present invention, since an orderly item-based index list is displayed, the user can effectively ascertain the content of the electronic document.

Moreover, according to an embodiment of the present invention, an index list citing reliable terms defined by electronic dictionaries can be created.

Furthermore, according to an embodiment of the present invention, it is possible to create an index list citing flexible terms based on extraction of specific expressions, without being influenced by electronic dictionaries.

Moreover, according to an embodiment of the present invention, weight conditions for each attribute in scoring are received, and scores are given for each attribute of specific expressions of an index item in the electronic document based on these weight conditions, making it possible to freely select which attribute of specific expressions (personal name, place name, or the like) is weighted, and thereby create an index list centered on personal names, place names, or the like. Accordingly, index lists can be created flexibly.

Furthermore, according to an embodiment of the present invention, since an orderly item-based index list is displayed, the user can effectively ascertain the content of a document.

Moreover, according to an embodiment of the present invention, not only character information but also multimedia such as audio files and image files can be extracted as index items.

Furthermore, according to an embodiment of the present invention, audio files and image files forming index items of an index list can be displayed orderly in an item-based list according to their attributes (classification of image or audio, file extension, or the like).

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer program product comprising a computer usable medium having computer readable program codes embodied in the medium that when executed causes a computer to execute:
extracting an index item that forms an index of an electronic document, together with appearing position information of the index item, from the electronic document; and
index-list creating including
creating link information that includes an appearing position in the electronic document of the extracted index item as a link, from the appearing position information;
attaching the created link information to the index item; and
creating an index list by arranging the index items to which the link information is attached.

2. The computer program product according to claim 1, wherein
the computer readable program codes further causes the computer to execute sorting the extracted index items based on a predetermined rule, and
the index-list creating includes creating an index list of the sorted index items.

3. The computer program product according to claim 1, wherein
the extracting includes extracting, by referring to an electronic dictionary in which a plurality of terms are defined, a term defined by the electronic dictionary from the electronic document as the index item.

4. The computer program product according to claim 1, wherein
the extracting includes
taking out a unique expression by giving a score for each attribute of the unique expressions in the electronic document; and
extracting the unit expression as the index item in association with the attribute having a highest score.

5. The computer program product according to claim 4, wherein
the computer readable program codes further causes the computer to execute receiving a weighting for each of the attributes in the scoring, and
the extracting includes giving a score for each of the attributes of the unique expressions in the electronic document based on the received weighting.

6. The computer program product according to claim 2, wherein
the sorting includes sorting the extracted index items based on at least one of appearing frequency, search usage frequency, alphabetical reading, and attributes, of the index items in the electronic document.

7. The computer program product according to claim 1, wherein
the extracting includes extracting at least one of an audio file and an image file in the electronic document as the index item, and
the index-list creating includes
creating link information that includes an appearing position of at least one of the audio file and the image file in the electronic document as a link, from the appearing position information;
attaching the created link information to the index item; and
creating an index list by arranging at least one of the audio file and the image file to which the link information is attached.

8. The computer program product according to claim 7, wherein
the computer readable program codes further causes the computer to execute sorting the extracted index items based on a predetermined rule, and
the sorting includes sorting the extracted index items by the index item extracting procedure according to an attribute of at least one of the audio file and the image file in the electronic document.

9. An apparatus for creating an index from an electronic document, the apparatus comprising:
an index-item extracting unit that extracts an index item that forms the index of the electronic document, together with appearing position information of the index item, from the electronic document; and
an index-list creating unit that creates link information that includes the appearing position in the electronic document of the extracted index item as a link, attaches the created link information to the index item, and creates an index list by arranging the index item to which the link information is attached.

10. A method of creating an index from an electronic document, the method comprising:
extracting an index item that forms the index of the electronic document, together with appearing position information of the index item, from the electronic document; and
index-list creating including
creating link information that includes the appearing position in the electronic document of the extracted index item as a link;
attaching the created link information to the index item; and
creating an index list by arranging the index item to which the link information is attached.
